(19) United States
(12) Patent Application Publication
(10) Pub. No.: US 2010/0073416 A1
(43) Pub. Date: Mar. 25, 2010

(54) LIQUID DROPLET EJECTION CONTROL APPARATUS AND LIQUID DROPLET EJECTING APPARATUS

(75) Inventor: Kenji YOKOTA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/561,308

(22) Filed: Sep. 17, 2009

(30) Foreign Application Priority Data
Sep. 24, 2008 (JP) 2008-244511

(51) Int. Cl. B41J 29/38

(52) U.S. Cl. 347/10

(57) ABSTRACT

In a liquid droplet ejection control apparatus, a plurality of head control (HC) boards are disposed in correspondence to ejectors that eject liquid droplets and are plurally arrayed in a liquid droplet ejecting head, and the HC boards are connected to each other in a daisy chain by a synchronization signal line. Each of the HC boards is equipped with a memory for storing identification information. When an identification signal representing the identification information is superimposed on a synchronization signal received via the synchronization signal line from a prior stage, the identification information that the identification signal represents is stored in the memory, the identification signal superimposed on the received synchronization signal is changed so as to represent identification information different from the identification information that the identification signal represents, and the synchronization signal on which the changed identification signal has been superimposed is transmitted to a later stage.

### CROSS-REFERENCE TO RELATED APPLICATION

This application claims priority under 35 USC 119 from Japanese Patent Application No. 2008-244511 filed on Sep. 24, 2008, the disclosure of which is incorporated by reference herein.

### BACKGROUND OF THE INVENTION

1. Field of the Invention

The present invention pertains to a liquid droplet ejection control apparatus and a liquid droplet ejecting apparatus and particularly relates to a liquid droplet ejection control apparatus and a liquid droplet ejecting apparatus disposed with head control units in which identification information is set.

2. Description of the Related Art

Liquid droplet ejecting apparatus that are disposed with a head in which nozzles that eject liquid droplets are plurally arrayed and which eject the liquid droplets onto a recording medium are known. Liquid droplet ejecting apparatus where plural control boards are disposed in correspondence to the plural nozzles arrayed in the head and where the head is driven by the plural control boards are also being developed in accompaniment with increases in the density and size of the head.

In the case of such a liquid droplet ejecting apparatus, it is necessary to identify and control each of the plural control boards. As a method of identifying each of the control boards, there is a method where DIP switches are mounted on the boards and identification information is set per control board manually by the DIP switches. Further, there is also a method of storing unique identification information beforehand in ROMs of each of the control boards.

For example, in Japanese Patent Application Laid-Open Publication (JP-A) No. 2007-1208, there is described a recording apparatus where unique numbers are written beforehand in EEPROMs disposed in boards for identifying ink tanks and where the boards after being written with the unique numbers are installed in the recording apparatus. Further, in JP-A No. 2008-12909, there is described a recording head that is equipped with control boards in which board number setting switches are installed.

It is necessary to perform setting of identification information not only at the time of manufacture of the liquid droplet ejecting apparatus but also when replacing a board. However, the work of writing identification information that identifies the control boards in ROMs or the like beforehand and setting the identification information by setting switches takes effort. Further, it is also easy for setting mistakes to occur.

### SUMMARY OF THE INVENTION

The present invention has been made in consideration of the above-described circumstances and provides a liquid droplet ejection control apparatus and a liquid droplet ejecting apparatus that can easily perform, with a simple configuration, setting of identification information with respect to a plurality of head control units that control the ejection of liquid droplets by a liquid droplet ejecting head.

A liquid droplet ejection control apparatus of a first aspect of the invention includes: a plurality of head control units disposed in correspondence to ejectors that eject liquid droplets and are plurally arrayed in a liquid droplet ejecting head, with the head control units being connected to each other in a daisy chain by a synchronization signal line to which a synchronization signal for determining an ejection timing of the liquid droplets is inputted, and with the head control units controlling the ejectors such that the liquid droplets are ejected from the ejectors in accordance with image data at the ejection timing corresponding to the synchronization signal that each of the head control units has received via the synchronization signal line, wherein each of the plurality of head control units includes a memory for storing identification information, a memory controller which, when an identification signal representing the identification information is superimposed on the synchronization signal that the head control unit has received, stores the identification information in the memory, and a transmitter transmitting, to a later stage, the synchronization signal on which the changed identification signal has been superimposed, the identification signal superimposed on the synchronization signal being changed so as to represent identification information different from the identification information that the identification signal represents, when an identification signal representing the identification information is superimposed on the synchronization signal that has been received; and wherein the liquid droplet control apparatus further comprises a main control unit that is connected via the synchronization signal line to the first head control unit of the plurality of head control units connected in a daisy chain and which, when storing identification information in the memories of the plurality of head control units, superimposes an identification signal on a synchronization signal and transmits the synchronization signal on which the identification signal has been superimposed to the first head control unit via the synchronization signal line.

This liquid droplet ejection control apparatus is equipped with the head control units that are connected in a daisy chain via the synchronization signal line. The head control units store, in their memories, the identification information that the identification signal superimposed on the synchronization signal that the head control units have received from a prior stage represents. Further, the head control units change the identification signal superimposed on the synchronization signal that the head control units have received so as to represent different identification information and transmit, to a later stage, the synchronization signal on which the changed identification signal has been superimposed. According to this configuration, setting of identification information with respect to a plurality of head control units that control the ejection of liquid droplets by a liquid droplet ejecting head can be easily performed with a simple configuration.

A liquid droplet ejection control apparatus of a second aspect of the invention includes: a plurality of head control units disposed in correspondence to ejectors that eject liquid droplets and are plurally arrayed in a liquid droplet ejecting head, with the head control units being connected to each other in a daisy chain by a synchronization signal line to which a synchronization signal for determining an ejection timing of the liquid droplets is inputted, and with the head control units controlling the ejectors such that the liquid droplets are ejected from the ejectors in accordance with image data at the ejection timing corresponding to the synchronization signal that each of the head control units has received via the synchronization signal line, wherein each of the plurality of head control units includes a memory for storing identification information, and a transmitter transmitting, to a later stage, the synchronization signal on which the changed dentification signal has been superimposed, the identification signal superimposed on the synchronization signal being changed so as to represent identification information different from the identification information that the identification signal represents, when an identification signal representing the identification information is superimposed on the synchronization signal that has been received; and wherein the liquid droplet ejection control apparatus further comprises a main control unit that is connected via the synchronization signal line to the first head control unit of the plurality of head control units connected in a daisy chain and which, when storing identification information in the memories of the plurality of head control units, superimposes an identification signal on a synchronization signal and transmits the synchronization signal on which the identification signal has been superimposed to the first head control unit via the synchronization signal line.

This liquid droplet ejection control apparatus is equipped with the head control units that are connected in a daisy chain via the synchronization signal line. The head control units change the identification signal superimposed on the synchronization signal that the head control units have received from a prior stage so as to represent different identification information and transmit, to a later stage, the synchronization signal on which the changed identification signal has been superimposed. Further, the head control units store the changed identification information in their memories. According to this configuration, setting of identification information with respect to a plurality of head control units that control the ejection of liquid droplets by a liquid droplet ejecting head can be easily performed with a simple configuration.

In the liquid droplet ejection control apparatus of the first or second aspect of the invention, the main control unit may be connected via the synchronization signal line to the last head control unit of the plurality of head control units connected in a daisy chain.

According to this configuration, the main control unit can understand whether or not the identification information has been stored in each of the head control units or whether or not an error has occurred during transmission on the basis of the synchronization signal that the main control unit receives from the last head control unit.

In the liquid droplet ejection control apparatus of the first or second aspect of the invention, the main control unit may be configured to stop superimposing the identification signal on the synchronization signal after the identification information has been stored in each of the memories of the plurality of head control units.

According to this configuration, a situation where noise occurs and the ejection timing shifts can be prevented.

In the liquid droplet ejection control apparatus of the first or second aspect of the invention, the main control unit and each of the plurality of head control units may be interconnected via a control signal line or a communication network, after the identification information has been stored in each of the memories of the plurality of head control units, the main control unit may add, to control information relating to control when ejecting the liquid droplets from the ejectors, identification information corresponding to that control information, and transmit, via the control signal line or the communication network, that control information, and when the ejection controllers of the plurality of head control units receive the control information to which the identification information corresponding to the identification information stored in the memories has been added, the ejection controllers may control ejection of the liquid droplets by the ejectors in accordance with the control information that the ejection controllers have received.

There is also control information that differs depending on the arrangement positions of the ejectors of the liquid droplet ejecting head. In this case, the control information becomes content corresponding to the positions (connection order) of the head control units connected in a daisy chain. The identification information is stored in the memories of the head control units as described above, so by adding, to control information corresponding to identification information, that identification information and transmitting that identification information, the head control units can control ejection of the liquid droplets by the ejectors in accordance with the control information with respect to themselves, and control corresponding to the ejectors becomes possible.

In the liquid droplet ejection control apparatus of the first or second aspect of the invention, the ejection controllers may control the ejectors such that the liquid droplets are ejected from the ejectors in accordance with the image data at an ejection timing where the ejection timing determined in accordance with the synchronization signal has been delayed by a correction value determined in accordance with the identification information stored in the memories.

The head control units are configured to receive the synchronization signal, process the synchronization signal as mentioned above and transmit the synchronization signal to the later-stage head control units. Because of this processing, a delay occurs in the reception timing of the synchronization signal. Thus, the head control units are configured such that, when the head control units perform ejection control based on the image data in accordance with the synchronization signal, ejection is controlled at an ejection timing where the ejection timing determined by the synchronization signal has been delayed by a correction value, whereby the problem of delay can be eliminated. The delay time is determined in accordance with the positions (connection order) of the head control units connected in a daisy chain. The identification information is stored in the memories of the head control units, so by correcting by the correction value determined in accordance with the identification information, the problem of delay can be eliminated.

A liquid droplet ejecting apparatus can be configured by a liquid droplet ejecting head in which ejectors that eject liquid droplets are plurally arrayed and the liquid droplet ejection control apparatus of the first or second aspect of the invention.

According to this configuration, setting of identification information with respect to a plurality of head control units that control the ejection of liquid droplets by a liquid droplet ejecting head can be easily performed with a simple configuration.

As described above, the present invention has the excellent effect that setting of identification information with respect to a plurality of head control units that control the ejection of liquid droplets by a liquid droplet ejecting head can be easily performed with a simple configuration.

### BRIEF DESCRIPTION OF THE DRAWINGS

FIG. 1 is a diagram showing an example of the configuration of a liquid droplet ejecting apparatus pertaining to the embodiment of the invention;

FIG. 2 is a diagram showing an example of the configuration of an HC board;

FIG. 3 is a diagram showing, in a case where the liquid droplet ejecting apparatus is disposed with four HC boards connected in a daisy chain via a synchronization signal line and HD boards corresponding to those four HC boards, a state of connection of each of the boards; and

FIG. 4A and FIG. 4B are diagrams showing examples of synchronization signals on which identification information is superimposed.

### DETAILED DESCRIPTION OF THE INVENTION

Below, an embodiment of the present invention will be described in detail on the basis of the drawings.

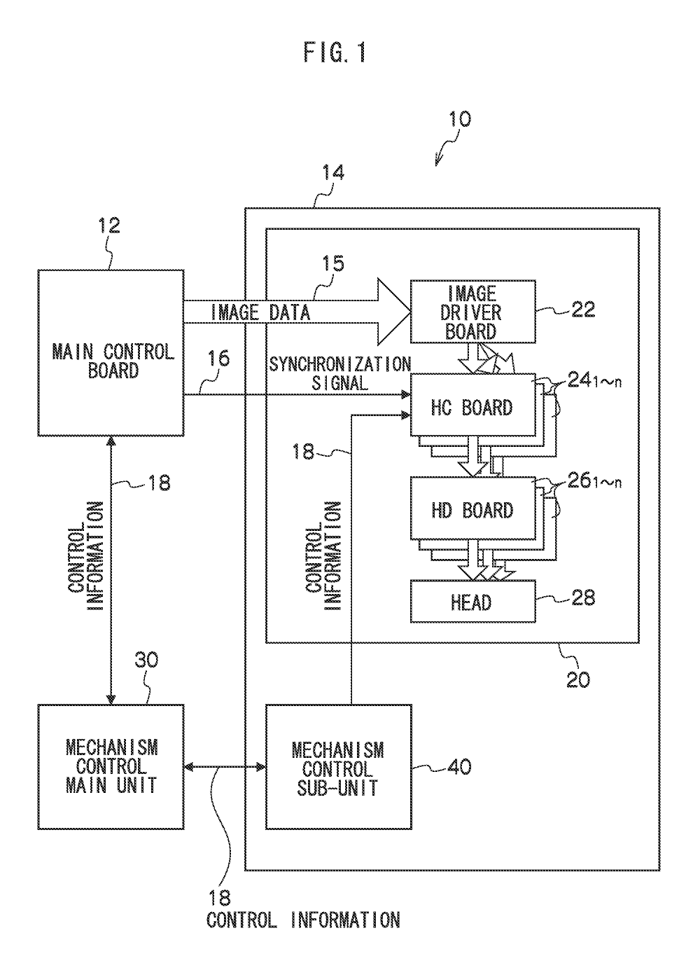

FIG. 1 is a diagram showing an example of the configuration of a liquid droplet ejecting apparatus 10 pertaining to the embodiment of the invention.

The liquid droplet ejecting apparatus 10 is equipped with a main control board 12, a head module 14 and a mechanism control main unit 30.

The main control board 12 is a board that is equipped with a CPU and various circuits that control the entire liquid droplet ejecting apparatus 10.

The head module 14 is equipped with a bar unit 20, in which a liquid droplet ejecting head 28 (hereinafter simply called “the head 28”) and control board groups of the head 28 are modularized, and a mechanism control sub-unit 40, which controls mechanisms around the head 28.

The mechanism control main unit 30 is a unit that includes boards that control mechanisms of the liquid droplet ejecting apparatus 10 other than those around the head 28, such as a conveyance mechanism that conveys a recording medium onto which liquid droplets are ejected by the head 28.

Below, each configuration in the head module 14 will be described in greater detail.

The bar unit 20 of the head module 14 is equipped with an image driver board 22, a plurality of head control (HC) boards 24_{1 to n}, a plurality of head driver (HD) boards 26_{1 to n}, and the head 28.

The head 28 is an elongate head in which nozzles that eject liquid droplets are plurally arrayed. In the present embodiment, the head 28 is disposed with ejecting mechanisms comprising pressure chambers to which a liquid to be ejected is supplied and in which that liquid is stored, nozzles that are communicated with the pressure chambers and drive elements that cause the pressures inside the pressure chambers to change. Drive signals are applied to the drive elements in accordance with image data, whereby the pressures inside the pressure chambers are caused to change such that liquid droplets are ejected from each of the nozzles onto the recording medium. The head 28 of the present embodiment has a length corresponding to the width of the recording medium, and recording with respect to the recording medium is performed by ejecting liquid droplets while conveying the recording medium in a direction intersecting the nozzle array direction while the head 28 remains fixed.

Here, the conveyance mechanism that conveys the recording medium will be described. A conveyor belt that conveys the recording medium is equipped with a drive roller. When the driving force of a motor is applied to the drive roller, the drive roller is driven to rotate such that the conveyor belt moves. Thus, the recording medium on the conveyor belt is conveyed from upstream in a conveyance direction in the direction of an image recording position of the head 28. These operations are controlled by the mechanism control main unit 30.

An encoder is attached to the drive roller. The encoder generates and outputs a square wave (encoder signal) in accordance with the rotation of the drive roller. The encoder signal is inputted to the main control board 12. The main control board 12 generates, on the basis of the encoder signal, a synchronization signal that becomes a reference signal when recording an image on the recording medium and outputs the synchronization signal to the HC boards 24_{1 to n} via a synchronization signal line 16. Because of the synchronization signal, the liquid droplet ejecting timing of the head 28 is stipulated.

The HC boards 24_{1 to n} are control boards that control the head 28 and are disposed per nozzle group when the plurality of nozzles are divided into n number (n is a whole number equal to or greater than 2) of nozzle groups along the nozzle array direction. The head 28 may also be configured by arranging and interconnecting, in the nozzle array direction, a plurality of head units in which pluralities of nozzles are arrayed. Additionally, the plurality of nozzles arrayed in each of the head units may be regarded as one coherent nozzle group, and the HC boards 24 may be disposed per head unit.

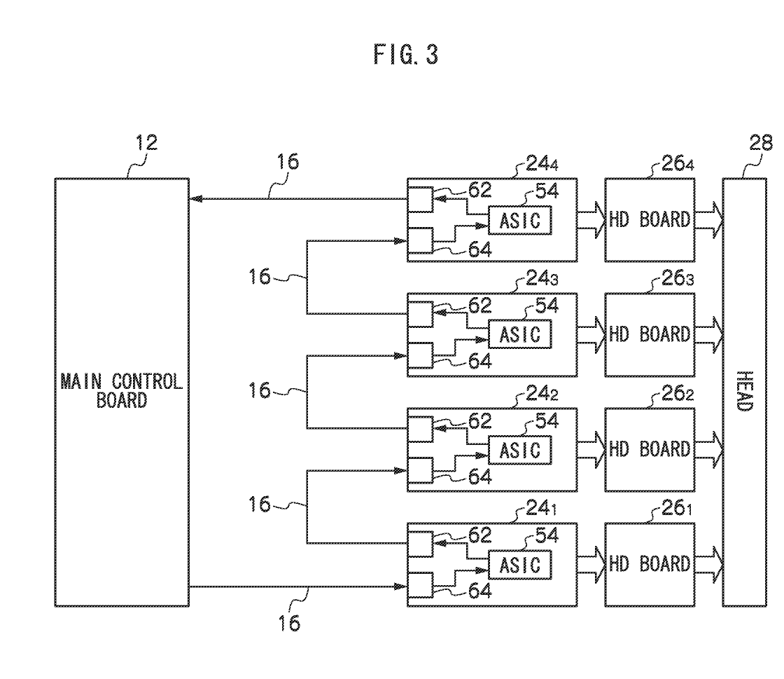

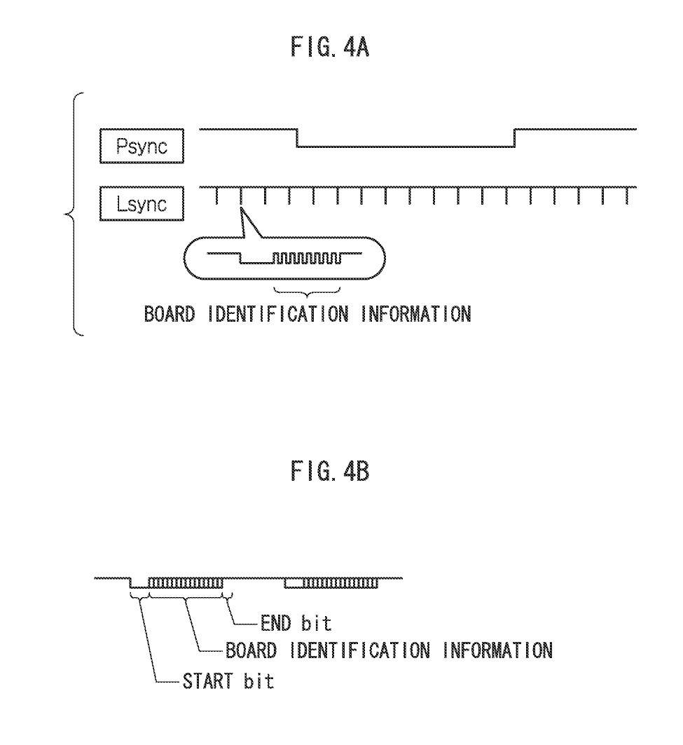

Further, the HC boards 24_{1 to n} are connected to each other in a daisy chain by the synchronization signal line 16 that inputs the synchronization signal (see FIG. 3 also). There are two types of synchronization signals: Psync and Lsync. Psync is a synchronization signal (vertical synchronization signal) of units of single pages of image data, and Lsync is a synchronization signal (horizontal synchronization signal) of units of single lines of image data (see FIG. 4A and FIG. 4B). Lsync is handled as a signal that is valid for image recording during a period when Psync is enabled (low level) and becomes invalid during other periods. Low voltage differential signaling (LVDS) or optical signaling may also be applied to the transmission and reception of the synchronization signal.

The HC boards 24_{1 to n} all share the same configuration, so when the HC boards 24_{1 to n} are described below without being differentiated, the final number will be omitted and the HC boards 24_{1 to n} will all be called the “the HC boards 24”. Further, the HD boards 26_{1 to n} also all share the same configuration, so when the HD boards 26_{1 to n} are described below without being differentiated, the final number will be omitted and the HD boards 26_{1 to n} will all be called the “the HD boards 26”.

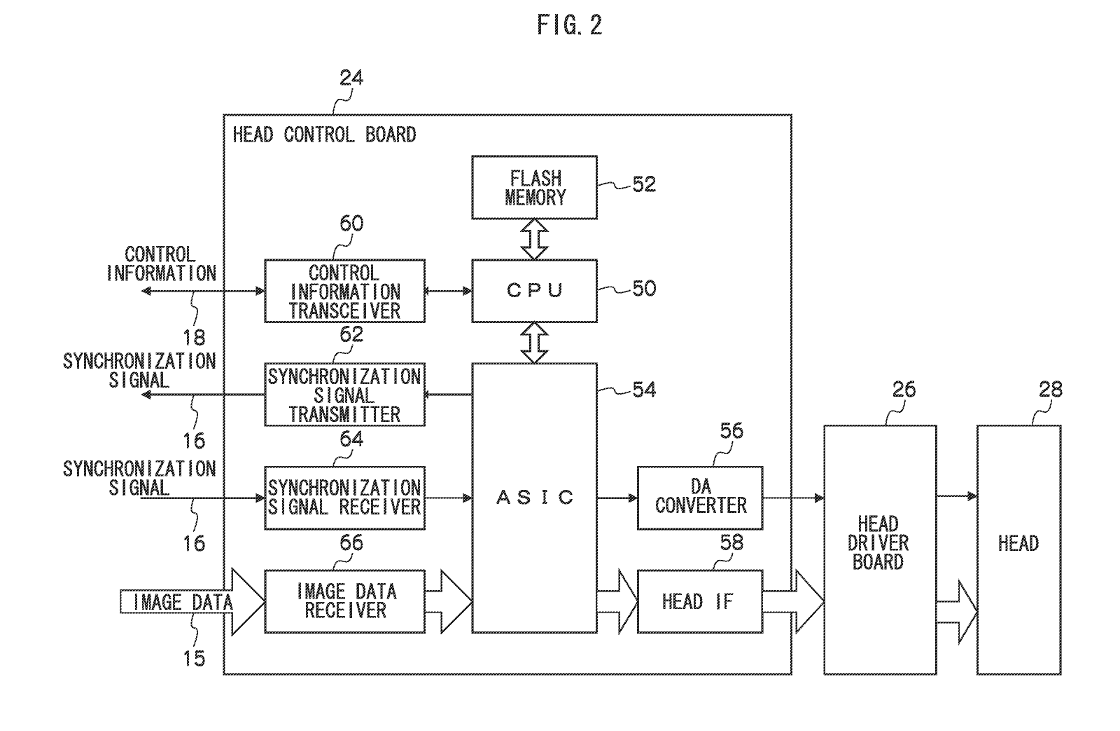

FIG. 2 is a diagram showing an example of the configuration of each of the HC boards 24. Each of the HC boards 24 is equipped with a central processing unit (CPU) 50, a flash memory 52, an application-specific integrated circuit (ASIC) 54, a digital/analog (DA) converter 56, a head interface (IF) 58, a control information transceiver 60, a synchronization signal transmitter 62, a synchronization signal receiver 64 and an image data receiver 66.

The CPU 50 is connected to the flash memory 52, the ASIC 54 and the control information transceiver 60. The CPU 50 controls the entire HC board 24 by executing a program stored in the flash memory 52.

Further, the CPU 50 generates a digital signal representing a voltage that becomes a reference of the drive signals applied to the drive elements corresponding to each of the nozzles of the head 28 on the basis of image data acquired by the ASIC 54 and outputs the digital signal to the DA converter 56 via the ASIC 54.

Further, the control information transceiver 60 is connected to a network 18 and transmits and receives various signals. The CPU 50 controls the ASIC 54 such that liquid droplets are ejected from the head 28 in accordance with control information received by the control information transceiver 60. The control information is transmitted from the main control board 12. Further, the CPU 50 transmits information and the like representing its current status and the like to a higher system such as the main control board 12 via the control information transceiver 60.

A program that the CPU 50 executes is stored beforehand in the flash memory 52. Further, as mentioned later, when identification information is acquired by the ASIC 54, that identification information is also recorded in the flash memory 52. The identification information is information for identifying each of the HC boards 24.

The ASIC 54 outputs, to the DA converter 56, the digital signal that has been inputted from the CPU 50 and also outputs, to the CPU 50 and the head IF 58, the image data that have been received by the image data receiver 66.

Further, when an identification signal is superimposed on the synchronization signal received by the synchronization signal receiver 64, the ASIC 54 inputs, to the CPU 50, identification information that the superimposed identification signal represents. The CPU 50 stores that identification information in the flash memory 52. Further, the ASIC 54 inputs, to the synchronization signal transmitter 62, the synchronization signal whose superimposed identification signal has been changed in accordance with a change rule determined beforehand.

The DA converter 56 converts the digital signal that has been inputted from the ASIC 54 into an analog signal and outputs the analog signal to the HD board 26. Further, the head IF 58 level-converts the image data that have been inputted from the ASIC 54 and outputs the image data to the HD board 26.

The synchronization signal transmitter 62 and the synchronization signal receiver 64 are connected to the synchronization signal line 16.

The synchronization signal receiver 64 receives the synchronization signal that has been transmitted from the prior-stage HC board 24 connected in a daisy chain. When the HC board 24 is the first HC board 24 connected in a daisy chain, the synchronization signal that has been transmitted from the main control board 12 is received. The synchronization signal that has been received by the synchronization signal receiver 64 is inputted to the ASIC 54.

The synchronization signal transmitter 62 transmits, to the later-stage HC board 24, the synchronization signal that has been inputted from the ASIC 54. When the HC board 24 is the last HC board 24 connected in a daisy chain, the synchronization signal is transmitted to the main control board 12.

The image data receiver 66 receives the image data from the image driver board 22.

Each of the HC boards 24 and each of the HD boards 26 are disposed in correspondence to each other. Each of the HD boards 26 is an analog driver board that applies drive signals with respect to the drive elements disposed in correspondence to each of the nozzles. When the digital signal that becomes a reference of the drive signals and the image data are inputted to the HD board 26 from the corresponding HC board 24, the HD board 26 amplifies the digital signal, generates drive signals, and applies the drive signals to the drive elements of the nozzles in accordance with the inputted image data.

The image driver board 22 is connected to the main control board 12 via an image data signal line 15. The image driver board 22 distributes and supplies, to each of the HC boards 24, the image data that have been received from the main control board 12 via the image data signal line 15. The HC boards 24 are, as mentioned before, disposed in correspondence to the arrangement positions of the nozzles, and it is necessary to transfer image data corresponding to the arrangement positions of the nozzles to the HC boards 24. Consequently, identification information that identifies each of the HC boards 24 is set in each of the HC boards 24 (stored in the flash memories 52), and the image data are distributed and supplied in accordance with the identification information set in the HC boards 24.

The mechanism control sub-unit 40 of the head module 14 is a unit that controls mechanisms around the head 28.

Further, the main control board 12, the mechanism control main unit 30, the mechanism control sub-unit 40 and the HC boards 24 are connected to the network 18, such as the Ethernet (registered trademark) or a controller-area network (CAN). These mutually transmit and receive control information and status information via the network 18. These may also be interconnected via a bus. Further, control information from the main control board 12 with respect to the HC boards 24 may also be transmitted to the HC boards 24 via the mechanism control main unit 30 and the mechanism control sub-unit 40.

Next, setting of the identification information with respect to the HC boards 24 of the present embodiment will be described with reference to FIG. 3. Here, “setting of the identification information” means storing the identification information in the flash memories 52 of the HC boards 24.

FIG. 3 is a diagram showing, in a case where the liquid droplet ejection apparatus 10 is disposed with four of the HC boards 24 (24₁, 24₂, 24₃ and 24₄) connected in a daisy chain via the synchronization signal line 16 and the HD boards 26 (26₁, 26₂, 26₃ and 26₄) corresponding to those four HC boards 24, a state of connection of each of the boards.

The HC boards 24₁ to 24₄ are disposed per group when the plurality of nozzles are divided into four groups along the nozzle array direction. Further, the four HC boards 24₁ to 24₄ are connected in a daisy chain in the order of the HC board 24₁, the HC board 24₂, the HC board 24₃ and the HC board 24₄ and are disposed in correspondence to each nozzle group along the nozzle array direction.

As shown in FIG. 3, the synchronization signal transmitter 62 of the first HC board 24₁ is connected via the synchronization signal line 16 to the synchronization signal receiver 64 of the later-stage HC board 24₂, the synchronization signal transmitter 62 of the HC board 24₂ is connected via the synchronization signal line 16 to the synchronization signal receiver 64 of the later-stage HC board 24₃, and the synchronization signal transmitter 62 of the HC board 24₃ is connected via the synchronization signal line 16 to the synchronization signal receiver 64 of the last HC board 24₄.

Further, the synchronization signal receiver 64 of the first HC board 24₁ is connected via the synchronization signal line 16 to the main control board 12, and the synchronization signal transmitter 62 of the last HC board 24₄ is connected via the synchronization signal line 16 to the main control board 12.

Because of this configuration, the synchronization signal that has been inputted from the main control board 12 to the first HC board 24 is sequentially inputted to the later-stage HC boards 24 such that the synchronization signal is eventually inputted to all of the HC boards 24.

In an initialization phase or the like after the HC boards 24 have been replaced, processing to set identification information in each of the HC boards 24 becomes necessary, and in the present embodiment, the liquid droplet ejecting apparatus 10 is configured such that identification information that identifies each of the HC boards 24 is automatically set by superimposing the identification information on the synchronization signal that is transmitted to the first HC board 24₁ connected in a daisy chain.

As shown in FIG. 4A, the main control board 12 superimposes an identification signal representing master information (here, as one example, “100”) serving as identification information on the synchronization signal Lsync, and transmits the synchronization signal to the first HC board 24. In the example shown in FIG. 4A, the main control board 12 transmits the synchronization signal Lsync on which the identification information has been superimposed during a high level period of the synchronization signal Psync. Further, the main control board 12 generates the identification signal such that it has a period different from the period of the synchronization signal Lsync on which that identification signal is to be superimposed (here, shorter than the period of the synchronization signal Lsync before superimposition) and superimposes the identification signal. In the present embodiment, the ejection timing is stipulated using the falling edge of the synchronization signal Lsync as a trigger. Consequently, the identification signal is placed in the empty portion after that falling edge.

FIG. 4B is a diagram showing one example of the synchronization signal Lsync on which the identification signal has been superimposed. As shown in FIG. 4B, the identification signal starts from a start bit whose relative period is long and whose falling edge serves as a trigger that stipulates the ejection timing, bits whose period is short follow after that, and an end bit representing the end of the signal follows after that.

When the synchronization signal Lsync on which the identification signal has been superimposed is received by the synchronization signal receiver 64 of the first HC board 24₁, the synchronization signal Lsync is inputted to the ASIC 54 of the HC board 24₁. The ASIC 54 of the HC board 24₁ extracts, as the identification signal, the signal whose period is short from the synchronization signal Lsync that has been received. The ASIC 54 of the HC board 24₁ inputs, to the CPU 50, the identification information 100 that the extracted identification signal represents. The CPU 50 stores the identification information 100 it has received in the flash memory 52. Thus, the identification information 100 is set in the first HC board 24₁.

Moreover, the ASIC 54 of the HC board 24₁ changes, in accordance with the change rule determined beforehand, the identification signal superimposed on the synchronization signal Lsync. In the present embodiment, the ASIC 54 changes the identification signal so as to represent identification information 101 obtained by adding 1 to the identification information 100 that the identification signal superimposed on the synchronization signal Lsync that has been received represents. Then, the ASIC 54 transmits the synchronization signal Lsync on which the changed identification signal has been superimposed to the later-stage HC board 24₂ via the synchronization signal transmitter 62.

When the synchronization signal Lsync on which the identification signal has been superimposed is received by the synchronization signal receiver 64 of the second HC board 24₂, the synchronization signal Lsync is inputted to the ASIC 54 of the HC board 24₂. Then, the ASIC 54 of the HC board 24₂ also extracts the identification signal as mentioned above. The ASIC 54 of the HC board 24₂ inputs the identification information 101 that the extracted identification signal represents to the CPU 50. The CPU 50 stores the identification information 101 it has received in the flash memory 52.

Moreover, the ASIC 54 of the HC board 24₂ changes, in accordance with the change rule, the identification signal superimposed on the synchronization signal Lsync as mentioned above. Then, the ASIC 54 of the HC board 24₂ transmits, to the later-stage HC board 24₃ via the synchronization signal transmitter 62, the synchronization signal Lsync on which has been superimposed the identification signal that has been changed so as to represent identification information 102 obtained by adding 1 to the identification information 101.

The third HC board 24₃ also similarly extracts the identification signal from the synchronization signal Lsync it has received, stores the identification information 102 that the identification signal represents in the flash memory 52, and transmits, to the later-stage HC board 24₄, the synchronization signal Lsync on which has been superimposed the identification signal representing identification information 103 obtained by adding 1 to the identification information 102.

The last HC board 24₄ also similarly extracts the identification signal from the synchronization signal Lsync it has received, stores the identification information 103 that the identification signal represents in the flash memory 52, and transmits, to the main control board 12, the synchronization signal Lsync on which has been superimposed the identification signal representing identification information 104 obtained by adding 1 to the identification information 103.

In this manner, mutually different identification information is set in the HC boards 24₁ to 24₄ in the order of 100, 101, 102 and 103.

The main control board 12 verifies the identification information that the identification signal superimposed on the synchronization signal Lsync transmitted from the last HC board 24₄ represents. Here, the main control board 12 understands beforehand the change rule of the identification information in the ASICs 54 of the HC boards 24 and the fact that there are four of the HC boards 24. The main control board 12 compares the identification information 104 in a case where the master information 100 has been changed by applying the change rule a number of times corresponding to the number (four) of the HC boards 24 and the identification information that the identification signal superimposed on the synchronization signal Lsync received from the last HC board 24₄ represents. When both values match, it is judged that the identification information has been normally set in each of the HC boards 24. When both values do not match, it is judged that the identification information has been abnormally and erroneously set due to a mistake in the connection of the HC boards 24 or the like.

After the identification information has been set in each of the HC boards 24 (stored in the flash memories 52), the main control board 12 stops superimposing the identification signal on the synchronization signal Lsync in order to avoid generating noise and transmits the synchronization signal on which the identification signal has not been superimposed. Consequently, the main control board 12 transmits the synchronization signal Lsync on which the identification signal is superimposed when necessary, such as at the time of initialization of the boards, and transmits the synchronization signal Lsync on which the identification signal is not superimposed when ejecting liquid droplets on the basis of image data. Consequently, the synchronization signal Lsync on which the identification signal is superimposed is normally not used for the ejection timing at the time of image data drawing.

In the present embodiment, the ASICs 54 are configured to process the synchronization signal Lsync as described above, regardless of whether or not the identification signal is superimposed thereon, and transmit the synchronization signal Lsync to the later-stage HC board 24. However, in the case of a synchronization signal on which the identification signal is not superimposed, the identification signal is not extracted, so the identification information stored in the flash memories 52 is not updated.

As described above, setting of identification information can be done automatically by superimposing an identification signal on a synchronization signal and transmitting the synchronization signal on which the identification signal has been superimposed, so identification information can be easily set by the above-described processing not only at the time of manufacture and shipping but also when necessary, such as when replacing a faulty board. Further, setting of identification information can be realized by a simple configuration where the HC boards 24, which have been designed such that the above-described synchronization signal processing is performed, are connected in a daisy chain via the synchronization signal line 16.

The present invention is not limited to the preceding embodiment, and various design changes can be made within the scope of the invention set forth in the claims.

For example, in the preceding embodiment, an example has been described where the identification signal was superimposed on the synchronization signal Lsync, but the identification signal may also be superimposed on the synchronization signal Psync. Even when the identification signal is superimposed on the synchronization signal Psync, effects that are the same as those described above are obtained by processing the identification signal in the same manner as in the preceding embodiment.

Further, there are also cases where noise enters the synchronization signal. In this case, there is also the potential for setting of the identification information to not be able to be performed correctly. Consequently, an error correction bit may be placed in the identification signal. Further, error determination may be performed by measuring the period of the synchronization signal.

Further, each of the HC boards 24 is configured such that the ASIC 54 receives the synchronization signal, processes the synchronization signal and thereafter delivers the synchronization signal to a later-stage board. Because of this processing, delay occurs. Thus, the ASICs 54 may be configured such that, when the HC boards 24 perform ejection control based on the image data in accordance with the synchronization signal, ejection is controlled at an ejection timing where the ejection timing determined by the synchronization signal has been delayed by a correction value, so that timing adjustment is performed between all of the HC boards 24.

For example, when a 20-clock delay arises in one of the HC boards 24, in the first HC board 24, the ejection timing is adjusted such that it is delayed by a delay time (correction value) corresponding to the number of all of the boards, and thereafter the correction value is reduced 20 clocks in the ASIC 54 of the respective HC boards 24 each time the synchronization signal passes through one of the HC boards 24, so that eventually the timings of all of the HC boards 24 are adjusted.

The correction value is determined in accordance with the identification information set in the HC boards 24. Each of the HC boards 24 can judge, from the stored identification information, what number the HC boards 24 are from the first HC board 24. Consequently, for example, by storing a delay time corresponding to the number of all of the boards and information of the delay time per one HC board 24 beforehand in the flash memories 52, the CPUs 50 can calculate a correction value corresponding to the identification information and can adjust the ejection timing by the correction value the CPUs 50 have calculated. Further, as mentioned later, control information representing the correction value may also be transmitted to, and stored in, each of the HC boards 24 from the main control board 12 via the network 18. According to this configuration, timing shifts can be prevented.

In liquid droplet ejection apparatus, sometimes the ejection characteristics of the nozzles (droplet velocities and ejection directions when the nozzles eject the liquid droplets) vary because of manufacturing variations, and shifts in the positions where the liquid droplets adhere occur. Further, sometimes the temperatures of the pressure chambers fluctuate because of ejection, the viscosities of the liquid inside the pressure chambers change such that the droplet velocities vary, and shifts in the positions where the liquid droplets adhere occur. Consequently, the timing when the nozzles eject the liquid droplets and the waveform of the drive signal may be corrected such that shifts in the positions where the liquid droplets adhere do not occur.

Such correction is sometimes performed in nozzle units, but it may also be performed using a correction value per nozzle group when a plurality of nozzles are divided into a plurality of nozzle groups as mentioned before, or it may be performed using a correction value per head unit when the head 28 is configured by interconnecting head units as mentioned before.

The correction value differs depending on the arrangement positions of the nozzles (or nozzle groups or head units). Further, as mentioned before, the identification information is set in the HC boards 24 in accordance with the connection order of the HC boards 24. Consequently, control information relating to the correction value is generated per piece of identification information and is transmitted to each of the HC boards 24 after identification information setting with respect to the HC boards 24.

This will be described more specifically below. The correction value is determined by performing a liquid droplet ejection test beforehand, and that information is stored per piece of identification information in the main control board 12. Then, after identification information setting, the identification information is added to the control information representing the correction value and is transmitted from the main control board 12 to the network 18 with respect to each of the HC boards 24.

When the HC boards 24 connected to the network 18 receive the control information to which the identification information corresponding to the identification information stored in the flash memories 52 has been added, the CPUs 50 store the control information in the flash memories 52 and perform control such ejection is performed in accordance with that control information at the time of driving the head 28.

The control information is not limited to information representing the correction value, and various information necessary for drive control of the head 28 can be supplied to the HC boards 24 as the control information.

Further, the change rule when changing the identification signal superimposed on the synchronization signal is not limited to the rule exemplified in the preceding embodiment. For example, +2 may be added to, or 1 may be subtracted from, the master identification information (the identification information that is transmitted to the first HC board 24). Further, the master identification information may be multiplied by a number determined beforehand.

Further, in the preceding embodiment, an example has been described where the HC boards 24 store the identification information that the identification signal superimposed on the synchronization signal transmitted from a prior-stage board represents, but the HC boards 24 may also store the identification information that has been changed by the change rule. For example, in the example described in the preceding embodiment, identification information of 100 is set in the HC board 24₁, identification information of 101 is set in the HC board 24₂, identification information of 102 is set in the HC board 24₃ and identification information of 103 is set in the HC board 24₄, but when the HC boards 24 store the changed identification information, identification information of 101 is set in the HC board 24₁, identification information of 102 is set in the HC board 24₂, identification information of 103 is set in the HC board 24₃ and identification information of 104 is set in the HC board 24₄. Even in the latter case, different identification information is set in the HC boards 24, so effects that are the same as those described above are obtained.

Further, in the preceding embodiment, the HC boards 24 were configured such that the ASICs 54 performed processing with respect to the synchronization signal, but the HC boards 24 may also be configured such that, instead of the ASICs 54, for example, field programmable gate arrays (FPGA) perform processing with respect to the synchronization signal.

What is claimed is:

1. A liquid droplet ejection control apparatus comprising: a plurality of head control units disposed in correspondence to ejectors that eject liquid droplets and are plurally
arrayed in a liquid droplet ejecting head, with the head control units being connected to each other in a daisy chain by a synchronization signal line to which a synchronization signal for determining an ejection timing of the liquid droplets is inputted, and with the head control units controlling the ejectors such that the liquid droplets are ejected from the ejectors in accordance with image data at the ejection timing corresponding to the synchronization signal that each of the head control units has received via the synchronization signal line,
wherein each of the plurality of head control units comprises
a memory for storing identification information,
a memory controller which, when an identification signal representing the identification information is superimposed on the synchronization signal that the head control unit has received, stores the identification information in the memory, and
a transmitter transmitting, to a later stage, the synchronization signal on which the changed identification signal has been superimposed, the identification signal superimposed on the synchronization signal being changed so as to represent identification information different from the identification information that the identification signal represents, when an identification signal representing the identification information is superimposed on the synchronization signal that has been received; and
wherein the liquid droplet control apparatus further comprises a main control unit that is connected via the synchronization signal line to the first head control unit of the plurality of head control units connected in a daisy chain and which, when storing identification information in the memories of the plurality of head control units, superimposes an identification signal on a synchronization signal and transmits the synchronization signal on which the identification signal has been superimposed to the first head control unit via the synchronization signal line.

2. The liquid droplet ejection control apparatus according to claim 1, wherein the main control unit is connected via the synchronization signal line to the last head control unit of the plurality of head control units connected in a daisy chain.

3. The liquid droplet ejection control apparatus according to claim 1, wherein the main control unit stops superimposing the identification signal on the synchronization signal after the identification information has been stored in each of the memories of the plurality of head control units.

4. The liquid droplet ejection control apparatus according to claim 1, wherein the plurality of head control units include ejection controllers that are disposed in correspondence to the plurally arrayed ejectors and control the ejectors such that the liquid droplets are ejected from the ejectors in accordance with the image data at the ejection timing corresponding to the synchronization signal.

5. The liquid droplet ejection control apparatus according to claim 4, wherein the main control unit and each of the plurality of head control units are interconnected via a control signal line or a communication network, after the identification information has been stored in each of the memories of the plurality of head control units, the main control unit adds, to control information relating to control when ejecting the liquid droplets from the ejectors, identification information corresponding to the control information and transmits, via the control signal line or the communication network, the control information, and when the ejection controllers of the plurality of head control units receive the control information to which the identification information corresponding to the identification information stored in the memories has been added, the ejection controllers control ejection of the liquid droplets by the ejectors in accordance with the control information that the ejection controllers have received.

6. The liquid droplet ejection control apparatus according to claim 4, wherein the ejection controllers control the ejectors such that the liquid droplets are ejected from the ejectors in accordance with the image data at an ejection timing where the ejection timing determined in accordance with the synchronization signal has been delayed by a correction value determined in accordance with the identification information stored in the memories.

7. A liquid droplet ejecting apparatus comprising:
a liquid droplet ejecting head in which ejectors that eject liquid droplets are plurally arrayed; and
the liquid droplet ejection control apparatus according to claim 1.

8. A liquid droplet ejection control apparatus comprising: a plurality of head control units disposed in correspondence to ejectors that eject liquid droplets and are plurally arrayed in a liquid droplet ejecting head, with the head control units being connected to each other in a daisy chain by a synchronization signal line to which a synchronization signal for determining an ejection timing of the liquid droplets is inputted, and with the head control units controlling the ejectors such that the liquid droplets are ejected from the ejectors in accordance with image data at the ejection timing corresponding to the synchronization signal that each of the head control units has received via the synchronization signal line,
wherein each of the plurality of head control units comprises
a memory for storing identification information, and
a transmitter transmitting, to a later stage, the synchronization signal on which the changed identification signal has been superimposed, the identification signal superimposed on the synchronization signal being changed so as to represent identification information different from the identification information that the identification signal represents, when an identification signal representing the identification information is superimposed on the synchronization signal that has been received; and
wherein the liquid droplet ejection control apparatus further comprises a main control unit that is connected via the synchronization signal line to the first head control unit of the plurality of head control units connected in a daisy chain and which, when storing identification information in the memories of the plurality of head control units, superimposes an identification signal on a synchronization signal and transmits the synchronization signal on which the identification signal has been superimposed to the first head control unit via the synchronization signal line.

9. The liquid droplet ejection control apparatus according to claim 8, wherein the main control unit is connected via the synchronization signal line to the last head control unit of the plurality of head control units connected in a daisy chain.

10. The liquid droplet ejection control apparatus according to claim 8, wherein the main control unit stops superimposing the identification signal on the synchronization signal after the identification information has been stored in each of the memories of the plurality of head control units.

11. The liquid droplet ejection control apparatus according to claim 8, wherein the plurality of head control units include ejection controllers that are disposed in correspondence to the plurally arrayed ejectors and control the ejectors such that the liquid droplets are ejected from the ejectors in accordance with the image data at the ejection timing corresponding to the synchronization signal.

12. The liquid droplet ejection control apparatus according to claim 11, wherein the main control unit and each of the plurality of head control units are interconnected via a control signal line or a communication network, after the identification information has been stored in each of the memories of the plurality of head control units, the main control unit adds, to control information relating to control when ejecting the liquid droplets from the ejectors, identification information corresponding to the control information and transmits, via the control signal line or the communication network, the control information, and when the ejection controllers of the plurality of head control units receive the control information to which the identification information corresponding to the identification information stored in the memories has been added, the ejection controllers control ejection of the liquid droplets by the ejectors in accordance with the control information that the ejection controllers have received.

13. The liquid droplet ejection control apparatus according to claim 11, wherein the ejection controllers control the ejectors such that the liquid droplets are ejected from the ejectors in accordance with the image data at an ejection timing where the ejection timing determined in accordance with the synchronization signal has been delayed by a correction value determined in accordance with the identification information stored in the memories.

14. A liquid droplet ejecting apparatus comprising:
a liquid droplet ejecting head in which ejectors that eject liquid droplets are plurally arrayed; and
the liquid droplet ejection control apparatus according to claim 8.

15. A liquid droplet ejection control apparatus comprising:
a plurality of head control units disposed in correspondence to ejectors that eject liquid droplets and are plurally arrayed in a liquid droplet ejecting head, with the head control units being connected to each other in a daisy chain by a synchronization signal line to which a synchronization signal for determining an ejection timing of the liquid droplets is inputted, and with the head control units controlling the ejectors such that the liquid droplets are ejected from the ejectors in accordance with image data at the ejection timing corresponding to the synchronization signal that each of the head control units has received via the synchronization signal line, and with each of the plurality of head control units being configured to store, when an identification signal representing the identification information is superimposed on the synchronization signal that the head control unit has received, the identification information that the identification signal represents, change the identification signal superimposed on the synchronization signal so as to represent identification information different from the identification information that the identification signal represents, and sequentially transmit, to a later stage, the synchronization signal on which the changed identification signal has been superimposed; and
a main control unit that is connected via the synchronization signal line to the first head control unit of the plurality of head control units connected in a daisy chain and transmits the synchronization signal on which the identification signal has been superimposed to the first head control unit.
